(19) United States
(12) Patent Application Publication
(10) Pub. No.: US 2022/0129890 A1
(43) Pub. Date: Apr. 28, 2022

(54) COMPLIANCE CONTROLLER FOR THE INTEGRATION OF LEGACY SYSTEMS IN SMART CONTRACT ASSET CONTROL

(71) Applicant: Bee Mortgage App, Inc., Lewes, DE (US)

(72) Inventor: Curtis Wood, Lewes, DE (US)

(21) Appl. No.: 17/572,150

(22) Filed: Jan. 10, 2022

Related U.S. Application Data
(63) Continuation-in-part of application No. 17/294,590, filed on May 17, 2021.
(60) Provisional application No. 62/855,965, filed on Jun. 1, 2019.

(51) Int. Cl. G06Q 20/38

(52) U.S. Cl. CPC G06Q 20/389

(57) ABSTRACT

The platform of the present disclosure may be configured to perform one or more methods via one or more systems to provide smart contract control over asset administration and management, where regulatory regimes may require the use of systems and protocols that would not otherwise be smart contract compatible by way of legal standards and/or technical constraints. Embodiments of the present disclosure may provide a compliance controller for integrating legacy system data and operations into a smart contract system in accordance with a regulated regime associated with an asset at the basis of the smart contract process. The platform may employ the compliance controller to interface the actions of the smart contract with the legacy systems associated with an asset controller operating outside of a blockchain corresponding to the smart contract. The asset controller may have off-chain control of the asset being administered and managed by the smart contract.

### RELATED APPLICATIONS

The present application is a Continuation-in-Part of U.S. application Ser. No. 17/294,590 filed on May 17, 2021, which claims priority to International Application No. PCT/US20/35628 filed on Jun. 1, 2020, which claims benefit under the provisions of 35 U.S.C. § 119(e) of U.S. Provisional Application No. 62/855,965 filed on Jun. 1, 2019, the entire contents of which are incorporated in this application by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to distributed ledger technology (DLT) integration with legacy systems. More specifically, the present disclosure relates to compliance protocols and integration parameters to control an asset that is governed both on the DLT (by smart contract deployments) and off the DLT (by asset oracles and controllers employing legacy systems).

### BACKGROUND

Some assets, such as financial instruments (e.g., notes) and legal instruments (e.g., property rights) may not be digitized assets compatible with smart contract control. Moreover, such assets may be governed by various legal and technical standards and constraints that fall well outside of the scope of the smart contract's operative control.

These assets may still, however, benefit from smart contract administration and management, in order to perform a desired action in association with the asset. The desired action to be performed, however, may be dependent upon the performance of one or more actions by an asset oracle (used herein interchangeably with “asset controller”). The asset oracle may reside outside of a DLT (or other blockchain technology in operative function with the smart contract) and be governed by regulatory regimes (e.g., legal and technical standards governing the disposition of the asset) which are not compatible with DLTs.

Moreover, the asset oracle may require certain compliance related data and integration parameters with its legacy systems that are capable of being performed through smart contracts deployed on a DLT. Thus, the asset oracle may require certain compliance related data and the performance of certain actions to affect the desired action upon the asset in a way that smart contract protocols do not have the technical capability to perform.

These oracles and legacy systems may not have the technical means to govern their processing under distributed ledger technologies and, therefore, may not be operative in a protocol compliant with smart contracts. As such, the oracles and associated legacy systems are not compatible with smart contract functionality and, therefore, do not enable an interfacing party to realize the technical advantages of smart contract functionality.

The lack of DLT adoption in various industries impedes the various technology advantages of smart contract functionality. The present disclosure provides solutions that may bridge the gap created between the adoption of DLT technology and the legacy systems in order to provide for smart contract control of a desired action relating to an asset under governance of legacy system protocols.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In one aspect, the present disclosure relates to a method for enabling smart contract asset control in conjunction with off-chain legacy systems in accordance to regulatory regimes surrounding the asset, the method comprising: defining smart contract initiation data comprising: interested party data, asset data, and a desired action to be performed with at least one interest party and at least one asset; identifying applicable regulatory regimes based on the smart contract initiation data, wherein identifying the applicable regulatory regimes comprises retrieving a list of regulatory regimes from a database of regulatory regimes, wherein the database of regulatory regimes comprises a listing of compliance parameters associated with each regulatory regime, wherein the listing of compliance parameters comprises a listing of technical standard associated with the applicable regulatory regime, wherein the technical standards are technical standards associated with off-chain protocols; deploying a smart contract based on, at least in part, on the following: a first set of instructions associated with the contract initiation data, and a second set of instructions associated with the compliance parameters; identifying an asset controller, wherein identifying the asset control operating comprises: accessing metadata associated with the asset controllers, the metadata comprising: compliance standards adhered to by the asset controller, and legacy systems employed by the asset controller, wherein the legacy systems are configured to provide operations and transfers of compliance actions and data required by the asset controller in order for the compliance controller to perform the at least one component of the desired action, and filtering a list of available asset controllers based on: the contract initiation data, and the compliance parameters, wherein filtering the list of available asset controllers based on the contract initiation data comprises filtering the list of available asset controllers based on each asset controllers' configuration to perform at least one component of the desired action specified in the contract initiation data, wherein the performance of the at least one component of the desired action by the asset controller comprises an off-chain performance outside of a scope of the smart contract's control, and wherein filtering the list of available asset controllers based on the compliance parameters comprises filtering the list of available asset controllers based on each asset controllers' compliance standards; determining requisite compliance actions for integrating with at least one asset controller of the filtered list of available asset controllers; wherein determining requisite compliance actions comprises determining: data to be shared and operations to be performed with the legacy systems such that the asset controller may be enabled to perform at least one component of the desired action specified in the contract initiation parameters; identifying the legacy systems associated with the at least one asset controller; determining interface parameters for interfacing with the legacy systems associated with asset controller; interfacing, based on the interface parameters, with the legacy system to perform the compliance actions required by the at least one controller, performing the requisite compliance actions, wherein performing the requisite actions comprises: a performance of an operation as required by the at least one asset controller, and a sharing of compliance data as required by the at least one asset controller; performing a plurality of performance tests with the at least one asset controller, wherein performing the plurality of performance tests comprises determining whether the at least one asset controller is capable to perform the at least one component of the desired action in accordance to target performance parameters; generating integration parameters based on results from the plurality of performance tests, wherein generating the integration parameters comprises: generating the integration parameters when at least one performance test has passed, the integration parameters comprising at least one term by which the at least one asset controller may perform the at least one component of the desired action; identifying a desired integration parameters for integrating smart contract control with the at least one asset controller associated with the legacy system; and causing a performance of the at least one component of the desired action based on the desired integration parameters, wherein causing the performance of the at least one component of the desired action comprises integrating the desired integration parameters within the smart contract.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates an example data flowchart for automating loan origination through a virtual processing, according to some embodiments of the present disclosure;

FIG. 2 illustrates an example data flowchart for initiating a user loan file, according to some embodiments of the present disclosure;

FIG. 3A illustrates example data flow for a loan estimate, wherein a user loan file has not been initiated;

FIG. 3B illustrates example data flow for a loan estimate, wherein a user loan file has been initiated and not complete;

FIG. 4 illustrates a platform configuration consistent with embodiments of the present;

FIG. 5 illustrates an example data flowchart for submitting and receiving loan dispositions, according to some embodiments of the present disclosure;

FIG. 6 illustrates example user interfaces during a loan estimation process, according to some embodiments of the present disclosure;

FIG. 7 illustrates an example flowchart;

FIG. 8A illustrates an example user device for interfacing with a virtual processing system, according to some embodiments of the present disclosure;

FIG. 8B illustrates an example user device for interfacing with a virtual processing system, according to some embodiments of the present disclosure;

FIG. 9 illustrates an example exchange of data between parties through a secure user loan file, according to some embodiments of the present disclosure;

FIG. 10 illustrates an example property purchase process, according to some embodiments of the present disclosure;

FIG. 11 illustrates a computing device compatible with various embodiments of the present disclosure;

FIG. 12 illustrates example method steps for processing a loan estimate request, according to some embodiments of the present disclosure;

FIG. 13 illustrates example loan estimation process steps, according to some embodiments of the present disclosure; and

FIG. 14 illustrates example method steps for completing incomplete qualifier test datapoint sets, according to some embodiments of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of loan origination, embodiments of the present disclosure are not limited to use only in this context. Rather, this context is submitted as an illustrative, non-limiting example, to on asset type applicable to the various embodiments of the present disclosure.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure provides a Compliance Controller for the Integration of Legacy Systems in Smart Contract Asset Control. Methods and systems described herein may be collectively referred to as the “platform”. The platform of the present disclosure may be configured to perform one or more methods via one or more systems to provide smart contract control over asset administration and management, where regulatory regimes may require the use of systems and protocols that would not otherwise be smart contract compatible by way of legal standards and/or technical constraints.

The platform may be configured to integrate the technical advantages of smart contract asset control with the regulatory regimes and protocols associated with various asset oracles and legacy systems they may employ, either directly or through third party providers. These oracles and legacy systems may not have the technical means to govern their processing under distributed ledger technologies and, therefore, may not operative in a protocol compliant with smart contracts. As such, the oracles and associated legacy systems are not compatible with smart contract functionality and, therefore, do not enable an interfacing party to realize the technical advantages of smart contract functionality.

Consistent with embodiments of the present disclosure, the platform may be configured to function in accordance to interested party data (e.g., the user types involved), associated asset data (e.g., the asset types involved), and a desired action to be performed with regard to the asset (e.g., a financial instrument, a legal right, or other form of asset). Collectively, these parameters may serve as contract initiation data for a smart contract.

It should be understood that the platform of the present disclosure may be used to affect a disposition of a plurality of asset types, including, for example, financial instruments (e.g., notes) and legal instruments (e.g., property rights). In certain embodiments, the assets may not be digitized assets compatible with smart contract control. Moreover, such assets may be governed by various legal and technical standards and constraints that fall well outside of the scope of the smart contract's operative control.

Furthermore, in various embodiments, the desired action to be performed with regard to the asset being administered by the smart contract may be dependent upon the performance of one or more actions by an asset oracle (used herein interchangeably with “asset controller”). The asset oracle may reside outside of a blockchain (or other distributed ledger technology in operative function with the smart contract) and be governed by regulatory regimes (e.g., legal and technical standards governing the disposition of the asset) that are not compatible with blockchain technologies. Moreover, the asset oracle may require certain compliance related data and integration parameters with its legacy systems that are not available through blockchain technologies. Thus, the asset oracle may require certain compliance related data and perform certain actions to affect the desired action upon the asset in a way that smart contract protocols do not have the technical capability to perform.

To address these problems, a platform consistent with embodiments of the present disclosure may be configured to enable the asset oracle (and it's corresponding legacy systems) to interface with blockchain based systems in order to affect an operation of the smart contract that is managing or administering the desired action to be performed with regard to the asset.

Still consistent with embodiments of the present disclosure may provide a compliance controller (referred to herein as the “main module”) for integrating legacy system data and operations into a smart contract system in accordance with a regulated regime associated with an asset at the basis of the smart contract process. The platform may employ the compliance controller to interface the actions of the smart contract with the legacy systems associated with an asset controller operating outside of a blockchain corresponding to the smart contract. The asset controller may have off-chain control of the asset being administered and managed by the smart contract.

In various embodiments, the compliance controller may be configured to integrate data communicated and processes performed with a legacy system into a smart contract process in accordance with regulations governing the asset at the basis of the smart contract process. In this way, the compliance controller may be responsible for the compliant integration of legacy systems with smart contract operations.

It is foreseeable that in such embodiments, the asset at the basis of the smart contract's administration and management cannot otherwise be manipulated by a smart contract without such compliant integration of data communicated and operations performed by legacy systems outside of the smart contract's control.

Thus, in the various embodiments disclosed herein, to deploy a smart contract process without the use of the compliance controller of the present invention may prevent the smart contract from meeting the standards and constraints established by a corresponding regulated regime governing the asset.

The compliance controller must be capable of working with various asset types and various regulatory regimes. In other words, a compliance controller must be ubiquitous/agnostic—it may be specifically designed for any one asset type or any one regulated regime.

The compliance controller of the present disclosure may employ the smart contract to generate the terms of the disposition of the asset in accordance to a desired asset action and the integration parameters it has established with legacy system integration parameters. The asset action is designated in the contract initiation data, and wherein the integration parameters are based on, at least in part, optimized performance parameters that were originally defined in the contract initiation data.

Still consistent with embodiments of the present disclosure, as one non-limiting example may provide, the platform may provide a process and method to organize and facilitate a secure and dependable loan management system that does not rely on the isolated experience of an individual. Accordingly, as one non-limiting example, the platform of the present disclosure may be configured to automate loan origination and estimation. In this non-limiting implementation example, a loan may be a financial instrument (e.g., asset) that is subject to a smart contract administration process of the present platform. Through the administration of the financial instrument, numerous regulatory regimes and protocols (e.g., legacy systems) must be adhered to.

Such regimes and protocols are not compatible with smart contract technologies. To address this problem, the platform may provide a compliance controller to enable the legacy systems to effectively operate with the smart contract in the administration of the financial instrument. In this way, the technical advantages of the smart contract technologies are realized within the loan origination and estimation process.

Some of the advantages include, but are not limited to, the elimination of dependency upon third parties (e.g., loan officers), the elimination of costs (e.g., origination fees), and the preservation of security and privacy. Furthermore, in some aspects, data automation of the present disclosure is fortified by trust enabled data validation protocols processing on a decentralized network replacing the human analytical decision-making dependency. In some embodiments, this data structure may lessen intermediary friction, human errors, and file defects by sharing real-time data on blocks of data processed by a network of nodes. In some aspects, multi-party smart contracts and automated processes may accelerate origination, fulfillment, settlement, and serving functions between multiple intermediary parties within the lending ecosystem, creating a complete blockchain origination and securitization loan lifecycle.

Most notably, one of the technical advantages of the present disclosure with regard to the aforementioned example, is that it may enable an aspect of loan origination to ensure that the end result remains compliant with a regulated regime governing the practice of loan origination while employing smart contracts throughout the process. This technical advantage is most apparent in view of conventional smart contracts systems failing to meet compliance with certain regulated regimes governing the asset under their control (e.g., a financial instrument such as a loan) as they do not have the compliance controller to interface with legacy systems.

Embodiments of the present disclosure may comprise methods, systems, and a computer readable medium comprising, but not limited to, at least one of the following:

A. An End User Interface Module (UI/API);

B. A Legacy Systems and Asset Oracle Interface Module;

C. A Data Store and Gathering Module;

D. A Smart Contract Module; and

E. A Main Module.

Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of these specifications. Each component disclosed for one module may be mixed with the functionality of another module. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 1100 may be employed in the performance of some or all of the stages disclosed with regard to the methods. Similarly, an apparatus may be employed in the performance of some or all of the stages of the methods. As such, the apparatus may comprise at least those architectural components as found in computing device 1100.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules disclosed herein. The method may be embodied as, for example, but not limited to, computer instructions, which when executed, perform the method. The method may comprise the following stages:
1. Smart Contract Initiation Inputs
2. Regulatory Regime Identification
3. Smart Contract Deployment
4. Asset Oracle and Controller Identification
5. Integration with Legacy Systems associated with the Asset Oracle/Controller
6. Interfacing the Smart Contract with the Legacy Systems
7. Establishing Integrated Solution
Optional Stages:
8. Selecting Integrated Solution
9. Establishing Smart Contract based on Integrated Solution Parameters
10. Deploying the Smart Contract

Although the aforementioned method has been described to be performed by the platform 400, it should be understood that computing device 1100 may be used to perform the various stages of the method. Furthermore, in some embodiments, different operations may be performed by different networked elements in operative communication with computing device 1100. For example, a plurality of computing devices may be employed in the performance of some or all of the stages in the aforementioned method. Moreover, a plurality of computing devices may be configured much like a single computing device 1100. Similarly, an apparatus may be employed in the performance of some or all stages in the method. The apparatus may also be configured much like computing device 1100.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 1100 may be employed in the performance of some or all of the stages disclosed with regard to the methods. Similarly, an apparatus may be employed in the performance of some or all of the stages of the methods. As such, the apparatus may comprise at least those architectural components as found in computing device 1100.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Consistent with embodiments of the present disclosure, a method may be performed by at least one of the aforementioned modules. The method may be embodied as, for example, but not limited to, computer instructions, which when executed, perform the methods below. The method may comprise, but not be limited to, the following stages.

1. Smart Contract Initiation Inputs—Stage 710

The platform may be configured to interface with a plurality of end user types (e.g., borrower, lender, loan officer, and other related third parties). The end user may be configured to provide inputs and view outputs via the interface module.

In various embodiments, the end user may be enabled to provide a series of inputs. The inputs may comprise, for example, a request for a smart contract to control an asset. In some embodiments, the inputs may be received through an application programming interface in communication with an external platform.

The asset at the foundation of the smart contract request may be regulated under a regulatory regime. The regulatory regime may involve asset oracles and controllers who play a role in the disposition of the asset, as it relates to the request for smart contract asset control. The asset oracles and controllers, however, may not have the necessary technical standards and interfaces necessary to communicate with the smart contract and vice versa. Accordingly, the platform of the present disclosure may provide a compliance controller (e.g., main module) be configured to enable the asset oracles and controllers having asset control to interface with the smart contract in order to fulfill the request.

The platform may compile the series of inputs (referred to as smart contract control parameters or contract initiation data) into the following data structure, illustrated here by way of non-limiting example:

a) Interested Party data: Personally Identifiable Information (PII) of at least one interested party and Other data related to at least one interested party in the disposition of the asset related to the smart contract control request;

b) Asset data: specifying the type of asset and related asset parameters (e.g., loan, amount; and

c) Asset-Based Action: specifying the action to be performed by the smart contract (e.g., loan origination) and performance parameters associated with the action (e.g., tolerances, conditional acceptance and rejection criteria).

Together with the series of inputs, the platform may be configured to generate a process datastore (PDS) and store the contract initiation parameters therein. The PDS may then be provided to, for example, legacy systems, for interfacing with asset controllers and oracles in order to affect the disposition of the asset in accordance with the smart contract control request parameters.

In turn, as will be discussed herein, the contract initiation data may be processed by asset oracles and legacy systems associated with asset oracles to generate a plurality of action proposals. The action proposals may be associated with the asset under control by the contract. Different legacy systems may offer different integration parameters, which may, in turn, result in different action proposals. The integration parameters proposed by each legacy system may be based on the legacy systems constraints, associate asset oracle/controller constraints, as well as one or more compliance standards corresponding to the regulatory regime governing the assets and parties that are subject to the desired asset action.

2. Regulatory Regime Identification—Stage 720

It is well known that various asset types are under the governance of various regulatory regimes. This applies to assets being controlled by a smart contract. However, as indicated above, the regulatory regimes may be implemented by parties (e.g., an asset controller or oracle) who employ legacy systems that are not compatible with blockchain technology or distributed ledger technologies.

Thus, in accordance with embodiments of the present disclosure, the platform may be configured to identify a plurality of regulatory regimes related to the asset under smart contract administration and management.

In a first instance, the platform may be configured to parse through the contract initiation data to identify the asset type and asset parameters (e.g., asset metadata), as well as asset action performance parameters (i.e., the desired action to be performed with the asset). The platform may then retrieve a list of regulatory regimes based on the asset data by accessing a data repository comprising the data (either internally or externally from the platform itself).

In a second instance, the platform may be configured to parse through the contract initiation data to identify the interested parties and associated parameters. For instance, the platform may obtain demographic data, location data, and other related data, and ascertain various regulatory regimes applicable to the interested parties.

The platform may further be configured to retrieve a listing of the regulatory regimes applicable to the asset of the smart contract by way of identifying the proper jurisdictions related to the regime, the asset, the parties, and the desired performance parameters.

Each regulatory regime may define requirement, or compliance parameters, upon any actor who may take actions with regard to the asset. For instance, by way of non-limiting example, technical standards as well as legal compliance requirements may be defined by the regulatory regime. Accordingly, as will be disclosed below, the platform must then adapt the smart contract operations as they relate to the administration and management of the asset to comply with those requirements. Compliance may include, however, that the smart contract interface with legacy systems under certain technical standards required by the regulatory regime.

3. Smart Contract Deployment—Stage 730

Having the regulatory regimes, associated compliance and technical standards, and the contract initiation data established, the platform may now deploy the smart contract. In some embodiments, the smart contract may be generated by the platform. For instance, the platform may reference a definitions and terms database that may be mapped to or otherwise associated with, for example, but not limited to, the regulatory regime's standards (i.e., the compliance parameters) and the contract initiation data.

In some embodiments, the platform may select from a database of pre-existing smart contracts, selected based on, for example, but not limited to, a mapping to the regulatory regime's standards and the contract initiation data. In yet further embodiments, the templated smart contracts may be customized to meet the specific requirements as defined by, for example, but not limited to, the regulatory regime's standards (i.e., the compliance parameters) and the contract initiation data.

Once established, the smart contract may be deployed on a blockchain technology suitable, as implemented by one of ordinary skill in the field of the present disclosure.

4. Asset Oracle and Controller Identification—Stage 740

According to embodiments of the present disclosure, the desired action to be performed in conjunction with the asset under smart contract management and administration may require an interested party to perform an action. That interested party may have off-chain access, control, and authority over the disposition of the asset in accordance to the desired action to be performed. The interested party may be referred to as the asset oracle or asset controller.

The platform of the present disclosure may be configured to identify a plurality of asset controllers based on, for example, but not limited to, a mapping of the compliance parameters and contract initiation data (which may comprise asset type data and interested party data).

Each asset controller may have metadata defining various properties of the asset controller. The metadata may be used to determine whether or not the asset controller is the appropriate controller to interface with the platform. The determination may be based on, for example, but not limited to, any one of the following: asset jurisdiction and other compliance requirements associated with the asset, as well as contract initiation data.

In various embodiments, the metadata may further specify which third parties and/or legacy systems are required by the asset controllers.

In turn, the platform may be configured to filter and select one or more desired legacy systems to undertake the performance parameters defined in the contract initiation data. In some embodiments, a user may be enabled to select the qualifying asset controllers. In one example, a borrower may apply for a mortgage (i.e., desired action) to purchase or refinance a home (i.e., asset type), and the borrow or loan officer may select a desired bank (e.g., asset controller). In some embodiments, the desired bank may be limited in selection based on, for example, but not limited to, the location of the user, the asset, compliance parameters associated with the regulatory regime.

Having identified the appropriate asset oracles, the platform may further be configured to identify legacy systems required for integration with the asset controller. The legacy systems may comprise a plurality of interface parameters. The interface parameters may not be compliant with DLT protocols and, thus, may not be accessible via smart contract execution alone. However, the platform must still interface with the legacy systems to perform the desired action as specified for the smart contract.

Accordingly, in this stage, the platform may have identified the appropriate asset controller and affiliated legacy systems necessary for compliant interface with the asset controllers, in order to affect the disposition of the asset under smart contract management and administration.

5. Additional Stages

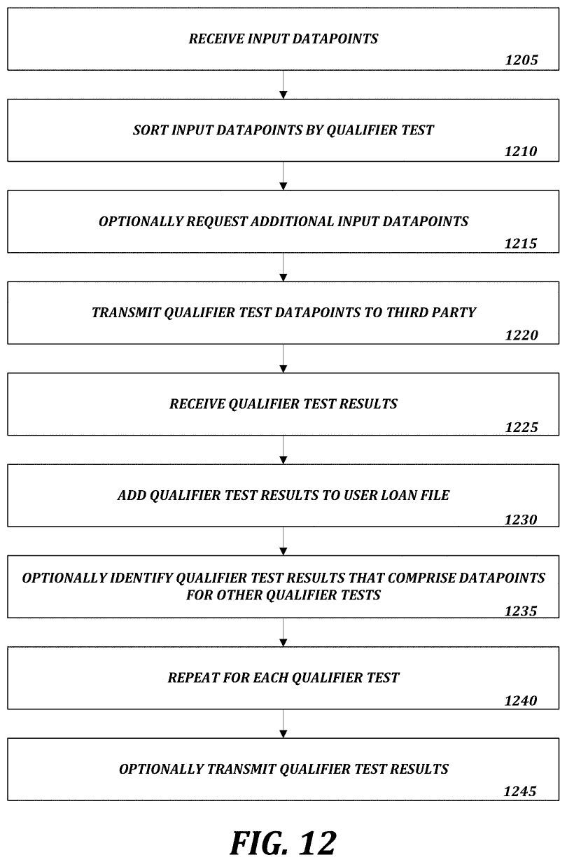

Referring now to FIG. 12, example process steps for providing a loan estimate through a VPS are illustrated. At 1205, a VPS may be activated, and user information may be input. At 1210, the VPS may format and sort the information to populate it into LOS. At 1215, the VPS may optionally request additional input datapoints. In some aspects, VPS may prepare collected data for a third party. At 1220, the VPS may transmit qualifier test datapoints to third party. At 1225, the VPS may receive the qualifier test results from the third party. At 1230, the VPS may add qualifier test results to user loan file. At 1235 the VPS may optionally identify qualifier test results that comprise datapoints for other qualifier tests. At 1240 the VPS may repeat the same process for each qualifier test. At 1245, the VPS may optionally transmit qualifier test results.

In some embodiments, a loan data file may be created or updated if the user is new to the system or not. In some aspects, the loan data may be updated in the system if it is a returning user.

In some embodiments, once information has been formatted the system may send the information into the system. In some aspects, the system may not have enough information to provide relevant or useful information from the system which may prompt a request for more information to the user. In some aspects, the user provided data may not meet the minimum requirements, prompting the system to request relevant information again to restart the process.

In some embodiments, if enough data has been input into the system by the user, the data may be used to pull and add data from a third party. In some implementations, once the third party has retrieved all relevant information the reviewed information may be sent back into the system and the loan data may be updated. In some aspects, once the loan data is updated the information may be sent to the LOS and underwriters. In some embodiments, the LOS may review the provided information, including information provided by third parties and underwriters. In some implementations, once both parties have reviewed the information, the information is compiled and the user may be alerted of loan options. In some aspects, a smart contract may be drawn up for the user to sign once loan options are presented.

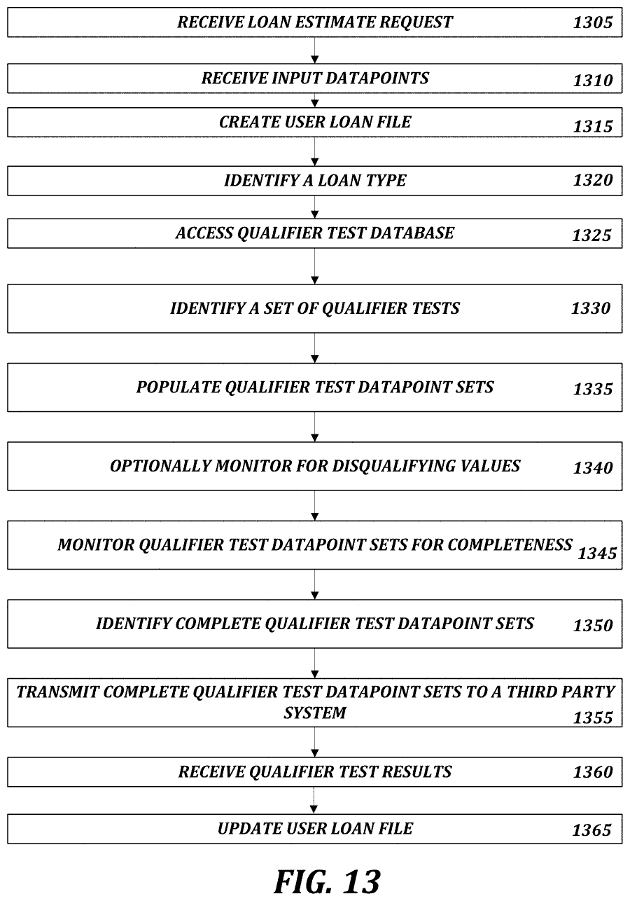

Referring now to FIG. 13, example loan estimation process steps are illustrated. At 1305, a loan estimate request may be received, such as from a user through a network device. At 1310, input datapoints may be received from a user. At 1315, a user loan file may be created, wherein the user loan file may initially comprise the input datapoints. In some aspects, the user loan file may be encrypted and accessed through blockchain technology, which may limit tampering or security risks. At 1320, a loan type may be identified, such as a mortgage loan, construction loan, auto loan, business loan, student loan, or refinancing loan, as non-limiting examples.

At 1325, a qualifier test database may be accessed, wherein the qualifier test database may comprise data related to different loan types, loan products, and qualifier tests. At 1330, a set of qualifier tests may be identified. In some aspects, each loan type and loan product may be associated with a predefined set of qualifier tests, wherein results from the set of qualifier tests may determine eligibility for a particular loan type or loan product.

At 1335, the qualifier test datapoint sets may be populated, such as with the input datapoints. In some aspects, at 1340, the data may be monitored for disqualifying values that may necessarily reject the user from eligibility for a loan that may be available through VPS. For example, disqualifying values may comprise a bankruptcy or tax lien. In some embodiments, disqualifying values may comprise qualifier test results that fall out of range for all loan products for that loan type. For example, for someone applying for a car loan, a credit score below 580 may eliminate their ability to receive any loan product. As another example, for someone applying for a mortgage, a debt to income ratio above 90%, may eliminate their ability to receive any mortgage loan products. As another example, for any type of loan, requesting a loan amount above the value of the property, project, or endeavor may eliminate the ability to receive that loan amount.

At 1345, completeness of the qualifier test datapoint sets may be monitored, wherein a complete qualifier test datapoint set may comprise data for datapoint within the set. At 1350, complete qualifier test datapoint sets may be identified. At 1355, complete qualifier test datapoint sets may be transmitted to their respective third party system configured to process the qualifier test datapoints and provide qualifier test results. At 1360, qualifier test results may be received. At 1365, the user loan file may be updated with populated qualifier test datapoint sets, input datapoints, and qualifier test results.

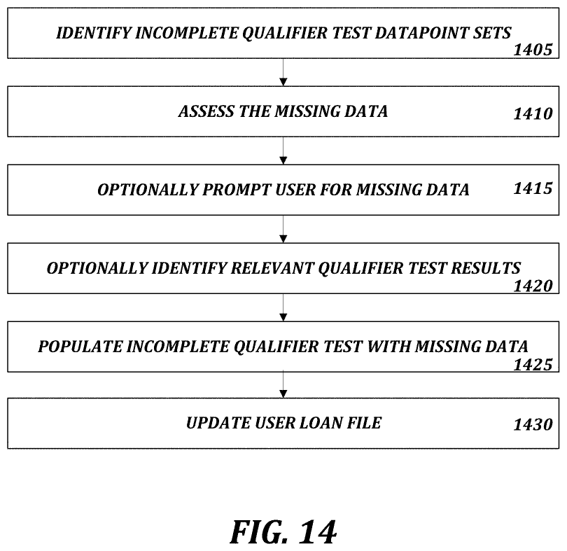

Referring now to FIG. 14, example method steps for completing incomplete qualifier test datapoint sets are illustrated. At 1405, incomplete qualifier test datapoint sets are illustrated. At 1410, missing data may be assessed and identified. In some aspects, at 1415, a user may be prompted for missing data. In some embodiments, at 1420, relevant qualifier test results may identified as part of the missing data. At 1425, an incomplete qualifier test may be populated with the missing data. At 1430, the user loan file may be updated. In some embodiments, the user loan file may be updated in real time, as datapoints are collected, sorted, and populated.

### III. Platform Configuration

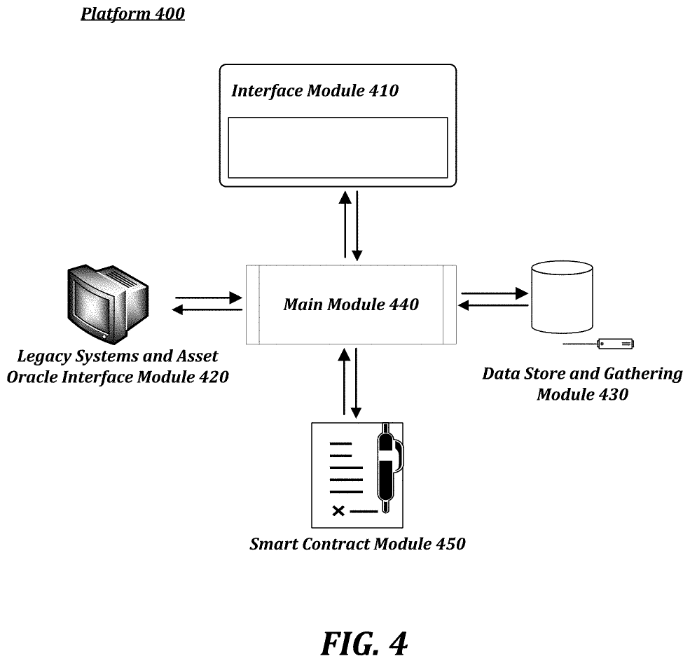

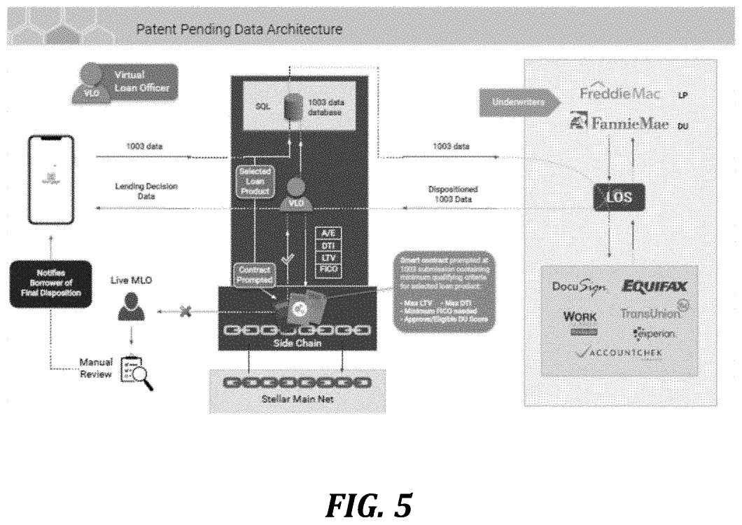

FIG. 4 illustrates one possible operating environment through which a platform consistent with embodiments of the present disclosure may be provided. By way of non-limiting example, a platform 400 for providing the methods and systems for may be hosted in both a blockchain protocol (“on-chain”) and off of a blockchain protocol (“off-chain”). It should be understood that layers and stages performed by the layers may be either “on-chain” or “off-chain.” The present disclosure anticipates embodiments with variations as to which stages may be performed “on-chain” or “off-chain.”

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 1100 may be employed in the performance of some or all of the stages disclosed with regard to the methods. Similarly, an apparatus may be employed in the performance of some or all of the stages of the methods. As such, the apparatus may comprise at least those architectural components as found in computing device 1100.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Consistent with embodiments of the present disclosure, a method may be performed by at least one of the aforementioned modules. The method may be embodied as, for example, but not limited to, computer instructions, which when executed, perform the methods below.

Accordingly, embodiments of the present disclosure provide a software and hardware platform comprised of a distributed set of computing elements, including, but not limited to:

A. End User Interface Module (UI/API)

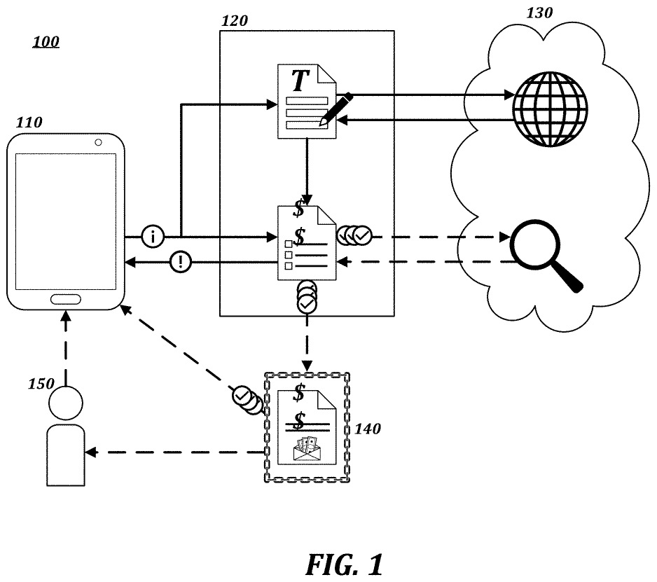

Referring now to FIG. 1, an example data flowchart 100 for Integration of Legacy Systems in Smart Contract Asset Control is illustrated. In some aspects, an end-user/interested party device 110 may be the main point of contact between the end-user/interested party and the information they give and receive to main module 440. In some embodiments, end-user/interested party device 110 may be a smart phone, smart device, laptop, or any other non-limiting example of a computing device. In some embodiments, once the application has been downloaded to end-user/interested party device 110 the flowchart 100 process may begin.

In some embodiments consistent with the present disclosure, the end-user and/or interested party may use at least one computing device, such as a smartphone, tablet, laptop, desktop, or any the device compatible with a computing device 1100 device to access the platform. In some embodiments, an end-user and/or interested party may access their user initiated contracts through a mobile device. In some embodiments, a downloadable version and/or web version may be available allowing for flexibility. In some implementations, each end-user/interested party may use a username and password based on specific criteria provided by the system to ensure all information is secure.

In some embodiments consistent with the present disclosure, different parties may have access to an initiated contract at one time. In some embodiments, the platform may track, tag, and implement each update. In some embodiments, the system may provide alerts or notifications to end-user/interested party device 110 if options change based on their input or updated information. In some implementations, all changes made to the initiated contract may be simultaneously updated through the system and all parties involved may be alerted each time a change is made regardless of who is currently accessing the platform. In some embodiments, all parties involved may receive copies of the disposition of the asset. In some embodiments, the system may coordinate disposition of the asset review as users move through the process.

In some embodiments consistent with the present disclosure, an end-user/interested party may enter data related to Personally Identifiable Information (PII) of at least one interested party, financial information, target property, and other information that may factor into the loan process depending on the loan type. In some implementations, once the information has been input into the system it may be prepared and formatted by the application for review by main module 440. In some aspects, the application may pull information regarding the user from legacy systems and asset oracle interface module 420. In some embodiments, legacy systems and asset oracle interface module 420 may use one or more third-party databases for verification of the information provided or qualifier test results, such as a credit score, rate quote, asset verification, income verification. in some implementations, legacy systems and asset oracle interface module 420 may use third party databases to pull additional information that may be required to aid in the loaning process. In some embodiments, the user may be prompted to input data to help the loan estimator generate better and more accurate Action Proposals.

In some embodiments consistent with the present disclosure, the process may be subject to manual review 150. In some implementations, main module 440 may flag input the user information and switch to manual review 150, such as where contract initiation parameters may conflict with compliance data. In some aspects, the manual review 150 process may override the results from main module 440 based on outside information or opinion that may aid an action proposal. In some embodiments, manual review 150 may occur after smart contract 140 has been accepted or generated to ensure all information is correct on main module 440 end and the contract initiation data. In some implementations, manual review may be based on the type asset and/or asset action end-user is requesting or selects.

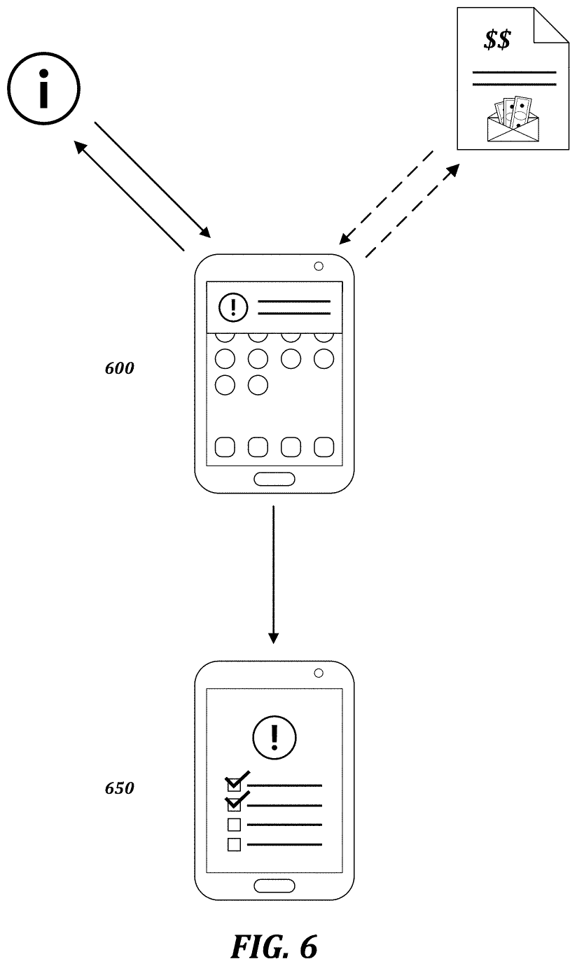

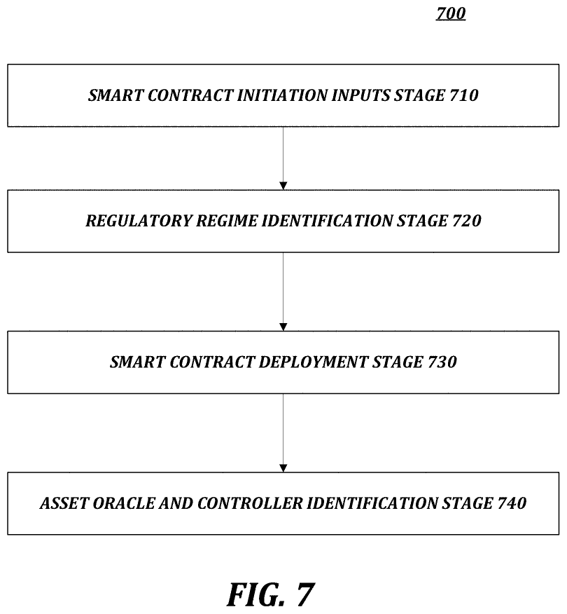

Referring now to FIG. 6, example a pending user interface 600 and a results interface 650 during the process are illustrated. In some embodiments, pending user interface 600 may alert the user when different actions occur with their asset control process. In some implementations, pending user interface 600 may alert the user when more information may be required to update their profile or input additional compliance requisite. In some aspects, the user may get an alert for every additional piece of information that is needed. For example, a user may get two separate alerts for an income qualifier datapoint and a credit score datapoint.

In some implementations, the user may receive alerts when new performance test results are available for review. In some aspects, the user may review their alerts on an alert or notification screen for the pending interface module interface 600. For example, all alerts that the user has on their system may be displayed together on an alert tab or screen on the device or in the system. In some embodiments, results interface 650 may be displayed once performance test results are received.

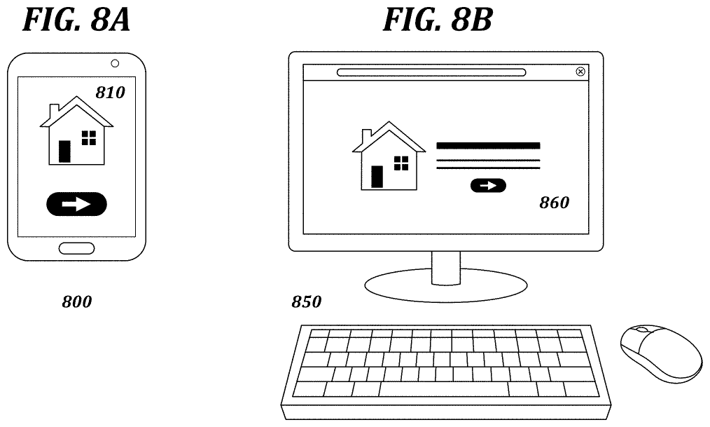

Referring now to FIGS. 8A-8B, user devices 800, 850 with example user interfaces 810, 860 are illustrated. In some aspects, the portable user device 800 may have full access and communication with the Interface Module 410. In some implementations, the portable user device 800 may be any smart device that can access the Interface Module. As non-limiting examples, a smart phone, tablet, and laptop may all be considered portable user devices 800, as well as any device compatible with a computing device 1100. In some aspects, data may be input directly, such as through use of a keyboard or a touch screen.

In some embodiments, at least a portion of interactions with the Interface Module may occur through voice activation. For example, a user may interact with a home virtual assistant and request an action proposal. The home virtual assistant may access the interface module, which may prompt a series of questions. User responses may be used to initiate a Process DataStore (PDS), which may be processed for the loan estimation process. In some implementations, the PDS generated by main module 440 may be accessed through the user's other devices after being created by a home virtual assistant. In some aspects, the interface module may request supporting documentation or additional data for the user to provide by some other means. In some embodiments, the home virtual assistant may ask different qualifying questions based on the loan type the user is inquiring about.

In some embodiments, the downloadable interface module interface 810 may be downloaded from an app store on a smart device and installed onto a mobile or smart device. For example, an iPhone user may go to the Apple Store and download a version of the downloadable Interface module interface 810 to their iPhone. In some embodiments, the downloadable interface module interface 810 may be a physical version that can be downloaded onto a non-mobile device. For example, a disk version may be purchased online or at a local store and installed on a non-mobile computing device such as a desktop computer so that the user has access to the system from their home or office.

In some aspects, a web interface module interface 860 may be used on a desktop user device 850. In some embodiments, the web interface module interface 860 may be accessed on a desktop user device 850. For example, if a user did not have access to a portable user device 810, they could go to an internet café, library, or any other non-limiting example that may have a desktop user device 850 and log into their profile through the secured web interface module interface 860. In some embodiments, the user may create a profile on the web Interface Module interface 860 that requires them to come up with a unique username and password.

In some embodiments, the username may be an email connected to the account, a user-generated username, or a random one assigned by the Interface Module to the user. In some implementations, the password may be a unique generated word or phrase by the user. In some aspects, the password requirements may include the password to have a symbol, uppercase letter, lowercase letter, certain length and other non-limiting examples that allows the user to create a unique password that only they would remember to gain access to their account.

In some embodiments, web interface module interface 860 may have a secured database within the system that limits security risk for unauthorized access to PDSs. In some implementations, web interface module interface 860 may have a firewall and other security measures that prevent accessibility of files and information of users on the site. For example, along with the username and password to protect the user a security system may be set up on the website's firewall to keep unwanted viruses and hackers out of the private system. In some aspects, there may be other security measures implemented to mask or protect user data and information. For example, record-keeping technology may be used to track the origin of a loan as it makes its way through the process.

B. Legacy Systems and Asset Oracle Interface Module

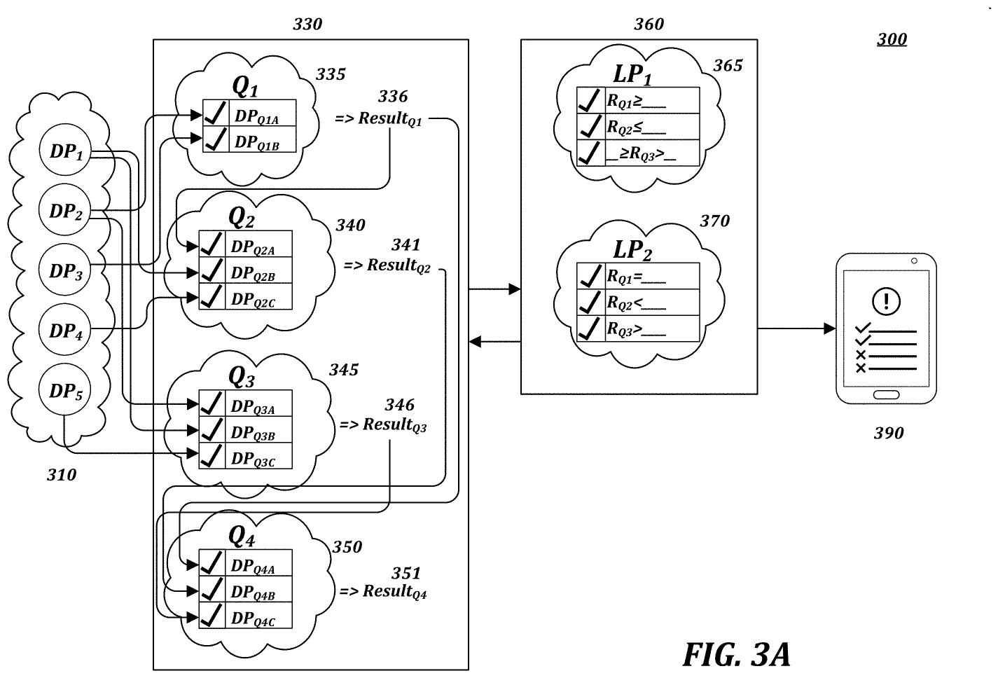

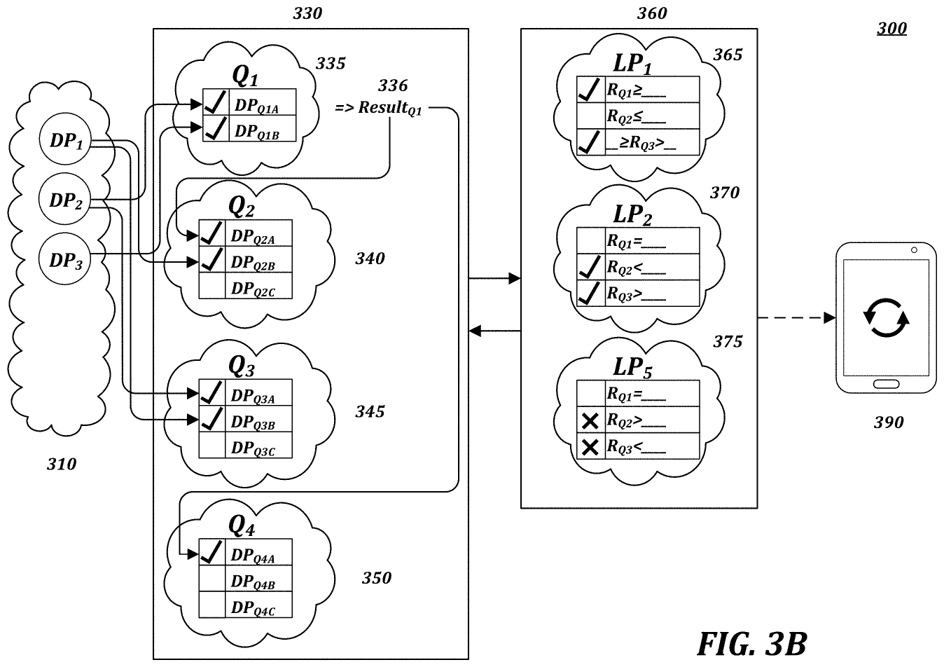

Referring now to FIG. 3C, example data flow 300 for Integration Parameters is illustrated, wherein a PDS has been completed. In some aspects, the data flow 300 may include a complete set of Contract Initiation Data 310. In some implementations, the Contract Initiation Data 310 may include data from Legacy Systems, such as, but not limited to FICO, VTL, DTI, housing information, employment information, and other non-limiting Compliance Requisites. In some implementations, the user may input more data via Interface Module throughout their time using the platform 400. For example, if the user's credit score changes, they may update it through the Interface Module, which may trigger a change in PT 365, 370.

C. Data Store and Gathering Module

a. PDS—230

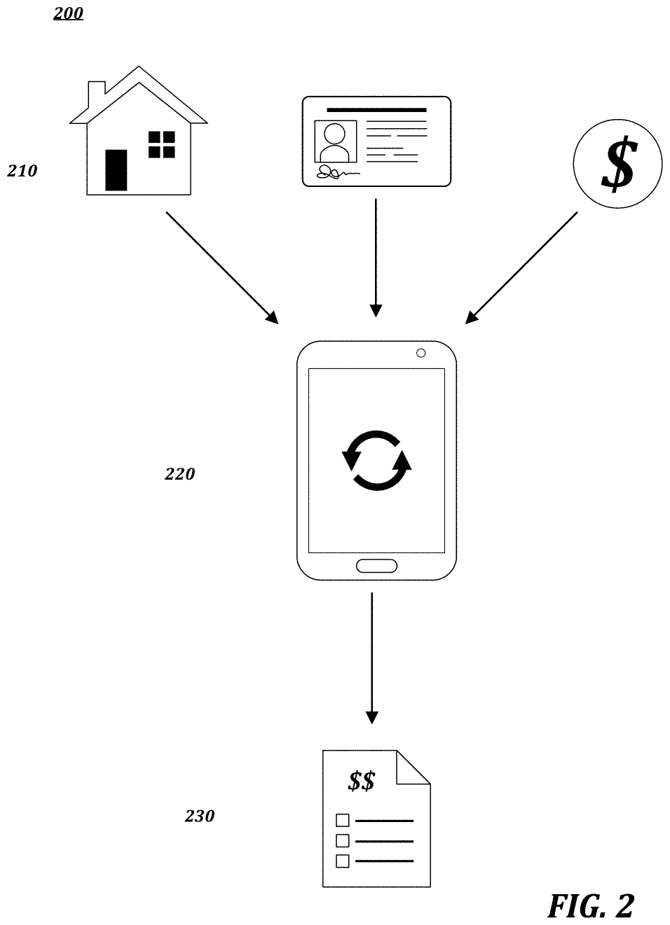

Referring now to FIG. 2, an example data flowchart 200 for initiating a Process Datastore (PDS) 230 is illustrated. In some aspects, the data input 210 may be user data inputted into main module 440 through an end-user/interested party device 110. In some embodiments, data input 210 may include property information, identification verification, income information, and other non-limiting examples. For example, the user may input their current housing information, income, a copy of their identification information, social security number, and other non-limiting information that may factor into data input 210. In some implementations, the information requested may depend on the Asset type and/or asset action the user is requesting.

In some embodiments, the end-user/interested party device 110 may be used to navigate the PDS 230 and help the user edit and create their data input 210 for the system. In some implementations, the end-user/interested party device 110 may be a smart phone, tablet, desktop computer, laptop, or any other non-limiting example that may allow the user to navigate the system, create and input their data input 210 and view their PDS 230. In some aspects, end-user/interested party device 110 may only access the PDS 230 through internet connection.

In some embodiments, the data input 210 and other information generated and input into the platform 400 may help create a PDS 230. In some implementations, the PDS 230 may be saved and used to create future asset control options. In some aspects, the PDS 230 may be updated or edited at any time by the user. In some embodiments, the updating process may affect the action proposals for the user based on the new information.

For example, on original input, a user's credit score may be too low, and the user may work to increase the credit score. Months later, the user may request an updated credit score, which may change the loan disposition. In some implementations, the PDS 230 may be saved to the platform 400 and viewed from other platforms and different users that have access to the PDS 230. In some embodiments, the PDS 230 may be secured through, for example, encryption technology, which may limit risk of tampering or security breaches. For example, the PDS 230 may be viewed by a manual loan officer or funder on a desktop computer as long as they have access to the information.

b. Simultaneous PDS Access—900

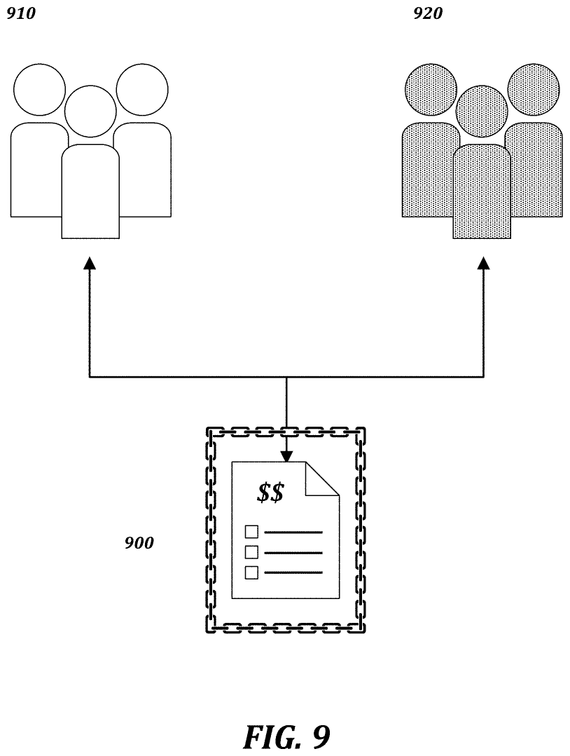

Referring now to FIG. 9, an example exchange of data between parties 910, 920 through a secure Process Datastore (PDS) 900 is illustrated. In some implementations, the PDS 900 may be reviewed by a plurality of parties 910, 920 during the review process, wherein some parties 910, 920 may need access to overlapping information with the PDS 900. In some aspects, the information of the PDS 900 may be updated through blockchain, which may limit risk of tampering or security breach. In some embodiments, both parties 910, 920 may add and receive information to the PDS 900. In some implementations, the information may be secured through some other record-keeping technology.

In some embodiments, party A 910 may add information to the PDS 900 while party B 900 is viewing the current information. In some embodiments, both party A 910 and party B 920 may access PDS 900 simultaneously despite accessing different portions of the PDS 900. For example, party A 910 could be adding Personal Identifiable Information (PII) information while party B is adjusting Asset information. In some aspects, PDS 900 may be updated in real time for each party 910, 920 as information is added, edited, and removed.

In some implementations, each party 910, 920 may receive notifications as the PDS 900 is edited. In some implementations, party A 910 may be an Interested Party such as end-user, such as a borrower, and party B may be an Asset Oracle and/or Legacy System, such as the lender or banking institution. In some aspects, the parties 910, 920 may be designated as having permission to access a PDS 900. In some embodiments, parties may be defined on a user by user basis, wherein only relevant parties may have access to a PDS 900. For example, a banking institution that is wholly unrelated to a PDS 900 may not have permission. In some embodiments, permitted parties 910, 920 may be changed and adjusted throughout the process. For example, a Legacy System, such as a credit score processing system, may not need access beyond the initial credit check process. As another example, a Legacy System, such as a title company may not need access to a PDS 900 until the sale is nearing closing.

c. Contract Initiation Data—310

Referring now to FIG. 3B, example data flow 300 for a loan estimate is illustrated, wherein a PDS has been initiated and not complete. In some aspects, the data flow 300 may occur as contract initiation data 310 is received. In some aspects, some of contract initiation data 310 may be pre-populated based on prior known information. For example, the user may have used the platform 400 before and they may already have input Contract Initiation Data 310 in the platform 400. In some embodiments, the contract initiation data 310 may depend on the Asset type and/or asset action.

D. Smart Contract Module

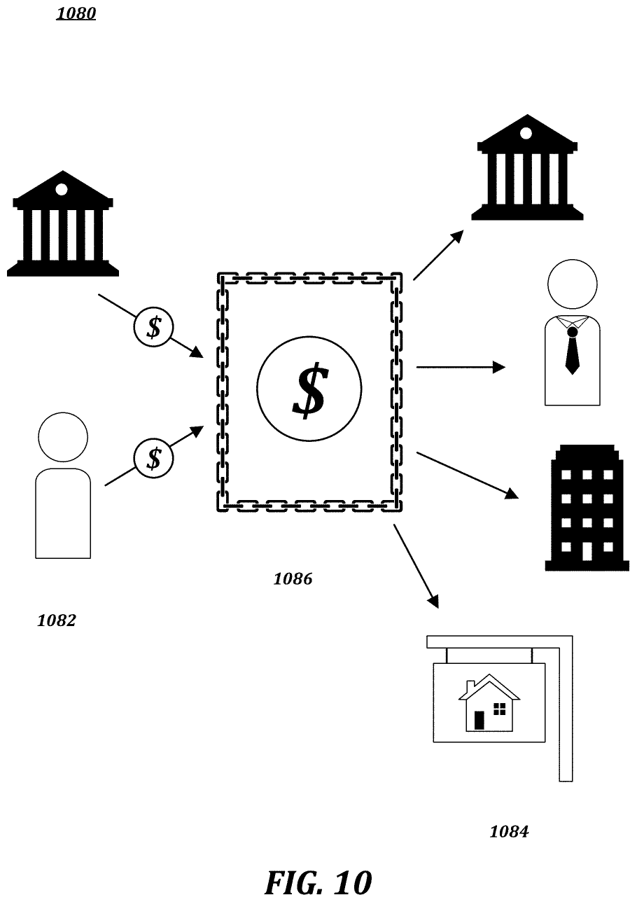

Referring now to FIG. 10B, an example of Smart Contract process 1010 is illustrated. In some aspects, the smart contract process 1000 may be initiated through an end-user/interested party device 110, such as through direct input or voice activation. In some aspects, end-user/interested party device 110 may be a smart phone, tablet, laptop or any non-liming example of a computing device 1100 that allows the user to access the system. In some embodiments, the end-user/interested party device 110 may allow for data input, sending and receiving information, and viewing results, as non-limiting examples.

In some embodiments, main module 440 may be a nexus between end-user/interested party device 110 and Legacy systems and asset oracle interface module 420, wherein main module 440 may receive data from end-user/interested party device 110 and sort the data to legacy systems and asset oracle interface module 420. In some implementations, the platform 400 may utilize artificial intelligence to accurately and effectively populate the PDS, wherein algorithms integrate the benefits associated with extensive experience of a plurality of trusted humans.

In some aspects, main module 440 may be used to collect contract initiation data for the smart contract process 1000 to provide accurate action proposals for the user. In some embodiments, legacy systems and asset oracle interface module 420 may be used to retrieve information from third parties. For example, legacy systems and asset oracle interface module 420 may be used to collect credit score, employment history, and other non-limiting factors that may help factor into the Integration Parameters.

In some implementations, a smart contract 140 may be created once sufficient information has been gathered and assessed by main module 440. In some aspects, user may qualify for action proposals, and once performance parameters are selected, smart contract 140 may be generated based on the information collected by main module 1014 from the user and legacy systems and asset oracle interface module 420. In some embodiments, smart contract 140 may be secured through blockchain technology, which may limit risk of tampering and may preserve the authenticity of smart contract 140.

In some implementations, after the smart contract 140 is generated, the user may choose to accept or reject options generated by main module 440. In some aspects, if Platform 400 was not able to generate smart contract 140 because the user does not meet the Compliance Requisites, the platform 400 may trigger a manual review 150. In some embodiments, manual review 150 may override platform 400 on a case to case basis. For example, if a user has low income but high property value and credit score manual review 150 may override platform 400 and grant the user a unique smart contract 140.

Referring now to FIG. 10A, an example funding process 1080 for collection and disbursement of encrypted funds is illustrated. In some embodiments, the funding process 1080 may occur within a secure environment 1086, such as Stellar mainnet. In some implementations, fund contributors 1082 may comprise an Asset Oracle, such as a lending bank, or an end-user, such as a buyer bringing funds to closing, as non-limiting examples. In some aspects, at closing, funds may be disbursed through the secure environment 1086 to fund recipients 1084.

In some implementations, the asset oracle may be a fund recipient 1084 if they are paying off an asset, or the asset oracle may be involved to accept the Asset from the user, such as a funder or buyer. In some aspects, fund recipients 1084 may include legacy systems, such as government agencies, escrow agencies, title companies, attorneys, or realtors, as non-limiting examples. In some embodiments, the title companies may be involved to ensure that the funds are properly disbursed.

E. Main Module

In some embodiments of the present disclosure, information may be formatted, confirmed, and sent through main module 440 to at least one asset oracle. In some embodiments, at least one asset oracle may directly interface with the legacy systems and asset oracle interface module 420. In some implementations, Compliance Requisites may be transmitted to main module 440. In some aspects, main module 440 may take information gathered from legacy systems and asset oracle interface module 420 and generate integration parameters that the user may select based on their contract initiation data. In some embodiments, the integration parameters may depend on the asset type an end-user selects.

a. Compliance Requisites and Performance Tests

In some embodiments, the input contract initiation data 310 may be sorted into Performance Test (PT) 335, 340, 345, 350 datapoint sets, referred to as Compliance Requisites herein. As Contract Initiation Data 310 is received, the PT 335, 340, 345, 350 compliance requisites may be populated. In some aspects, population may occur in real time. In some embodiments, population may occur in data sets, such as personal information, tax information, and property information, and other PII as non-limiting examples. The aforementioned datasets may be generated based on Contact Initiation Data 310.

In some implementations, as a PT1 335 Compliance Requisite is complete, main module 440 may transmit the PT1 335 Compliance Requisite to at least one Legacy System, such as external or third party system, that may execute the PT utilizing the PT1 335 compliance requisite. The third party may transmit the results back to main module 440, wherein the results may be stored within a PDS. In some aspects, a PT1 Compliance Requisite 336 may comprise a necessary datapoint set for PT2 340, which may be populated in real time. In some implementations, Contract Initiation Data 310 may apply to multiple PT 335, 340, 345, 350, such as birthdate, social security number, name, and other Personally Identifiable Information (PII).

In some embodiments, as results are collected, they may be compared to Compliance Requisites for a set of PT 365, 370, 375. As they are compared, failed PT 375 may be removed as soon as enough information is collected to disqualify the PT 375, such as too low of a credit score. In some implementations, a user device 390 may indicate that the Action Proposal is pending and currently being processed. In some aspects, main module 440 may eliminate and filter some action proposals, such as a 15-year or 30-year loan term. In some embodiments, preference prompts may change and adjust based on contract initiation data 310 and PT 335, 340, 345, 350 results comprising compliance requisites. For example, a 15-year loan term may initially be an option, but as main module 440 processes the user information, a 15-year loan term may not be feasible, and the option may be removed.

b. Action Proposals

In some aspects, each PT 335, 340, 345, 350 may be associated with unique PT results 336, 341, 346, 351 based on the individual criteria of each test. For example, PT1 335 may collect personal information for a credit score from a legacy system, such as FICO, and PT3 345 may collect property information from another legacy system, such as Zillow, for FICO. In some aspects, if Compliance Requisites for a PT 335, 340, 345, 350 are incomplete, the user may not be presented with an Action Proposal 360. In some embodiments, predefined results may halt the process. For example, an income below a predefined threshold, may preclude a user from integration with an Asset Oracle. In some aspects, a user may request that a rejected PDS be manually reviewed.

In some aspects, the results from each PT 335, 340, 345, 350 may directly affect the PT 365, 370. In some embodiments, the user device 390 may allow the user to access their PT 365, 370 and choose what they would like to accept or reject. In some implementations, the user device 390 may allow the user to communicate with a loan officer during the manual review process if it needs to happen. In some aspects, the platform may provide information related to the details of each PT 365, 370, allowing for an informed decision where a user may have multiple PT 365, 370.

### IV. Computing Device Architecture

Platform 400 may be embodied as, for example, but not be limited to, a website, a web application, a desktop application, backend application, and a mobile application compatible with a computing device 1100. The computing device 1100 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;

Platform 400 may be hosted on a centralized server or a cloud computing service. Although the disclosed methods have been described to be performed by a computing device 1100, it should be understood that, in some embodiments, different operations may be performed by a plurality of the computing devices 1100 in operative communication at least one network.

Embodiments of the present disclosure may comprise a system having a central processing unit (CPU) 1120, a bus 1130, a memory unit 1140, a power supply unit (PSU) 1150, and one or more Input/Output (I/O) units. The CPU 1120 coupled to the memory unit 1140 and the plurality of I/O units 1160 via the bus 1130, all of which are powered by the PSU 1150. It should be understood that, in some embodiments, each disclosed unit may actually be a plurality of such units for the purposes of redundancy, high availability, and/or performance. The combination of the presently disclosed units is configured to perform the stages any method disclosed herein.

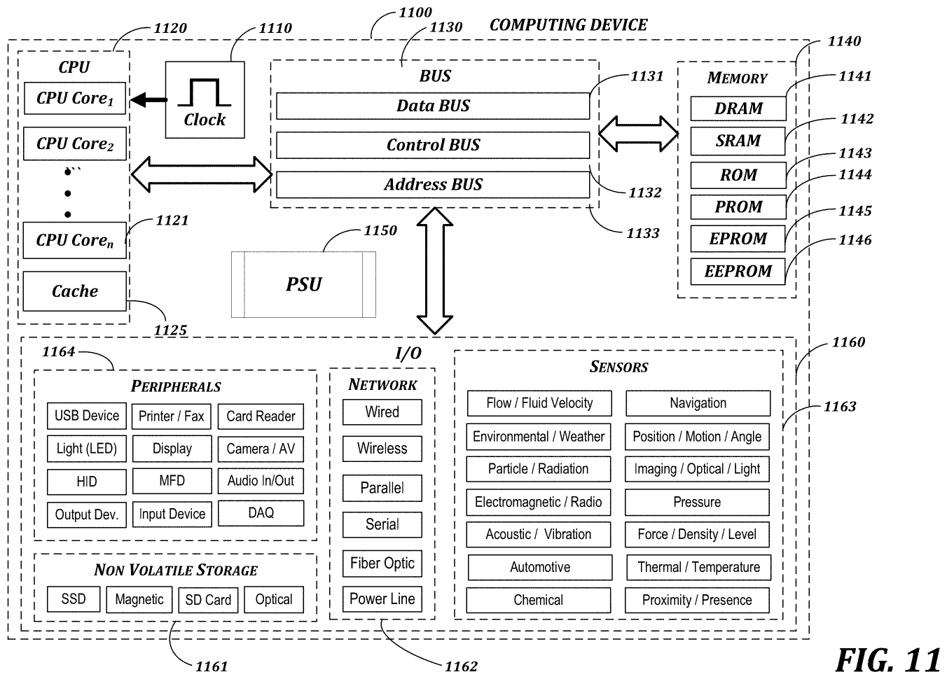

FIG. 11 is a block diagram of a system including computing device 1100. Consistent with an embodiment of the disclosure, the aforementioned CPU 1120, the bus 1130, the memory unit 1140, a PSU 1150, and the plurality of I/O units 1160 may be implemented in a computing device, such as computing device 1100 of FIG. 11. Any suitable combination of hardware, software, or firmware may be used to implement the aforementioned units. For example, the CPU 1120, the bus 1130, and the memory unit 1140 may be implemented with computing device 1100 or any of other computing devices 1100, in combination with computing device 1100. The aforementioned system, device, and components are examples and other systems, devices, and components may comprise the aforementioned CPU 1120, the bus 1130, the memory unit 1140, consistent with embodiments of the disclosure.

At least one computing device 1100 may be embodied as any of the computing elements illustrated in all of the attached figures, including [list the modules and methods]. A computing device 1100 does not need to be electronic, nor even have a CPU 1120, nor bus 1130, nor memory unit 1140. The definition of the computing device 1100 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 1100, especially if the processing is purposeful.

With reference to FIG. 11, a system consistent with an embodiment of the disclosure may include a computing device, such as computing device 1100. In a basic configuration, computing device 1100 may include at least one clock module 1110, at least one CPU 1120, at least one bus 1130, and at least one memory unit 1140, at least one PSU 1150, and at least one I/O 1160 module, wherein I/O module may be comprised of, but not limited to a non-volatile storage sub-module 1161, a communication sub-module 1162, a sensors sub-module 1163, and a peripherals sub-module 1164.

A system consistent with an embodiment of the disclosure the computing device 1100 may include the clock module 1110 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 1120, the central component of modern computers, which relies on a clock. The only exceptions are asynchronous circuits such as asynchronous CPUs. The clock 1110 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 1100 use a “clock multiplier” which multiplies a lower frequency external clock to the appropriate clock rate of the CPU 1120. This allows the CPU 1120 to operate at a much higher frequency than the rest of the computer, which affords performance gains in situations where the CPU 1120 does not need to wait on an external factor (like memory 1140 or input/output 1160). Some embodiments of the clock 1110 may include dynamic frequency change, where, the time between clock edges can vary widely from one edge to the next and back again.

A system consistent with an embodiment of the disclosure the computing device 1100 may include the CPU unit 1120 comprising at least one CPU Core 1121. A plurality of CPU cores 1121 may comprise identical the CPU cores 1121, such as, but not limited to, homogeneous multi-core systems. It is also possible for the plurality of CPU cores 1121 to comprise different the CPU cores 1121, such as, but not limited to, heterogeneous multi-core systems, big.LITTLE systems and some AMD accelerated processing units (APU). The CPU unit 1120 reads and executes program instructions which may be used across many application domains, for example, but not limited to, general purpose computing, embedded computing, network computing, digital signal processing (DSP), and graphics processing (GPU). The CPU unit 1120 may run multiple instructions on separate CPU cores 1121 at the same time. The CPU unit 1120 may be integrated into at least one of a single integrated circuit die and multiple dies in a single chip package. The single integrated circuit die and multiple dies in a single chip package may contain a plurality of other aspects of the computing device 1100, for example, but not limited to, the clock 1110, the CPU 1120, the bus 1130, the memory 1140, and I/O 1160.

The CPU unit 1120 may contain cache 1122 such as, but not limited to, a level 1 cache, level 2 cache, level 3 cache or combination thereof. The aforementioned cache 1122 may or may not be shared amongst a plurality of CPU cores 1121. The cache 1122 sharing comprises at least one of message passing and inter-core communication methods may be used for the at least one CPU Core 1121 to communicate with the cache 1122. The inter-core communication methods may comprise, but not limited to, bus, ring, two-dimensional mesh, and crossbar. The aforementioned CPU unit 1120 may employ symmetric multiprocessing (SMP) design.

The plurality of the aforementioned CPU cores 1121 may comprise soft microprocessor cores on a single field programmable gate array (FPGA), such as semiconductor intellectual property cores (IP Core). The plurality of CPU cores 1121 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 1121, for example, but not limited to Instruction-level parallelism (ILP) such as, but not limited to, superscalar pipelining, and Thread-level parallelism (TLP).

Consistent with the embodiments of the present disclosure, the aforementioned computing device 1100 may employ a communication system that transfers data between components inside the aforementioned computing device 1100, and/or the plurality of computing devices 1100. The aforementioned communication system will be known to a person having ordinary skill in the art as a bus 1130. The bus 1130 may embody internal and/or external plurality of hardware and software components, for example, but not limited to a wire, optical fiber, communication protocols, and any physical arrangement that provides the same logical function as a parallel electrical bus. The bus 1130 may comprise at least one of, but not limited to a parallel bus, wherein the parallel bus carry data words in parallel on multiple wires, and a serial bus, wherein the serial bus carry data in bit-serial form. The bus 1130 may embody a plurality of topologies, for example, but not limited to, a multidrop/electrical parallel topology, a daisy chain topology, and a connected by switched hubs, such as USB bus. The bus 1130 may comprise a plurality of embodiments, for example, but not limited to: Consistent with the embodiments of the present disclosure, the aforementioned computing device 1100 may employ hardware integrated circuits that store information for immediate use in the computing device 1100, know to the person having ordinary skill in the art as primary storage or memory 1140. The memory 1140 operates at high speed, distinguishing it from the non-volatile storage sub-module 1161, which may be referred to as secondary or tertiary storage, which provides slow-to-access information but offers higher capacities at lower cost. The contents contained in memory 1140, may be transferred to secondary storage via techniques such as, but not limited to, virtual memory and swap. The memory 1140 may be associated with addressable semiconductor memory, such as integrated circuits consisting of silicon-based transistors, used for example as primary storage but also other purposes in the computing device 1100. The memory 1140 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 1141, Static Random-Access Memory (SRAM) 1142, CPU Cache memory 1125, Advanced Random-Access Memory (A-RAM), and other types of primary storage such as Random-Access Memory (RAM).
Non-volatile memory which can retain stored information even after power is removed, for example, but not limited to, Read-Only Memory (ROM) 1143, Programmable ROM (PROM) 1144, Erasable PROM (EPROM) 1145, Electrically Erasable PROM (EEPROM) 1146 (e.g. flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 1100 may employ the communication system between an information processing system, such as the computing device 1100, and the outside world, for example, but not limited to, human, environment, and another computing device 1100. The aforementioned communication system will be known to a person having ordinary skill in the art as I/O 1160. The I/O module 1160 regulates a plurality of inputs and outputs with regard to the computing device 1100, wherein the inputs are a plurality of signals and data received by the computing device 1100, and the outputs are the plurality of signals and data sent from the computing device 1100. The I/O module 1160 interfaces a plurality of hardware, such as, but not limited to, non-volatile storage 1161, communication devices 1162, sensors 1163, and peripherals 1164. The plurality of hardware is used by the at least one of, but not limited to, human, environment, and another computing device 1100 to communicate with the present computing device 1100. The I/O module 1160 may comprise a plurality of forms, for example, but not limited to channel I/O, port mapped I/O, asynchronous I/O, and Direct Memory Access (DMA).

Consistent with the embodiments of the present disclosure, the aforementioned computing device 1100 may employ the non-volatile storage sub-module 1161, which may be referred to by a person having ordinary skill in the art as one of secondary storage, external memory, tertiary storage, off-line storage, and auxiliary storage. The non-volatile storage sub-module 1161 may not be accessed directly by the CPU 1120 without using intermediate area in the memory 1140. The non-volatile storage sub-module 1161 does not lose data when power is removed and may be two orders of magnitude less costly than storage used in memory module, at the expense of speed and latency. The non-volatile storage sub-module 1161 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (1161) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO)
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor
Magnetic storage such as, but not limited to, Hard Disk Drive (HDD), tape drive, carousel memory, and Card Random-Access Memory (CRAM)
Phase-change memory
Holographic data storage such as Holographic Versatile Disk (HVD)
Molecular Memory
Deoxyribonucleic Acid (DNA) digital data storage

Consistent with the embodiments of the present disclosure, the aforementioned computing device 1100 may employ the communication sub-module 1162 as a subset of the I/O 1160, which may be referred to by a person having ordinary skill in the art as at least one of, but not limited to, computer network, data network, and network. The network allows computing devices 1100 to exchange data using connections, which may be known to a person having ordinary skill in the art as data links, between network nodes. The nodes comprise network computer devices 1100 that originate, route, and terminate data. The nodes are identified by network addresses and can include a plurality of hosts consistent with the embodiments of a computing device 1100. The aforementioned embodiments include, but not limited to personal computers, phones, servers, drones, and networking devices such as, but not limited to, hubs, switches, routers, modems, and firewalls.

Two nodes can be said are networked together, when one computing device 1100 is able to exchange information with the other computing device 1100, whether or not they have a direct connection with each other. The communication sub-module 1162 supports a plurality of applications and services, such as, but not limited to World Wide Web (WWW), digital video and audio, shared use of application and storage computing devices 1100, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g. TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g. Global System for Mobile Communications [GSM], General Packet Radio Service [GPRS], Code-Division Multiple Access [CDMA], and Integrated Digital Enhanced Network [IDEN]).

The communication sub-module 1162 may comprise a plurality of size, topology, traffic control mechanism and organizational intent. The communication sub-module 1162 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength)
Parallel communications, such as, but not limited to, LPT ports.
Serial communications, such as, but not limited to, RS-232 and USB
Fiber Optic communications, such as, but not limited to, Single-mode optical fiber (SMF) and Multi-mode optical fiber (MMF)
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 1100 may employ the sensors sub-module 1163 as a subset of the I/O 1160. The sensors sub-module 1163 comprises at least one of the devices, modules, and subsystems whose purpose is to detect events or changes in its environment and send the information to the computing device 1100. Sensors are sensitive to the measured property, are not sensitive to any property not measured, but may be encountered in its application, and do not significantly influence the measured property. The sensors sub-module 1163 may comprise a plurality of digital devices and analog devices, wherein if an analog device is used, an Analog to Digital (A-to-D) converter must be employed to interface the said device with the computing device 1100. The sensors may be subject to a plurality of deviations that limit sensor accuracy. The sensors sub-module 1163 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 1100 may employ the peripherals sub-module 1162 as a subset of the I/O 1160. The peripheral sub-module 1164 comprises ancillary devices uses to put information into and get information out of the computing device 1100. There are 3 categories of devices comprising the peripheral sub-module 1164, which exist based on their relationship with the computing device 1100, input devices, output devices, and input/output devices. Input devices send at least one of data and instructions to the computing device 1100. Input devices can be categorized based on, but not limited to:
Modality of input, such as, but not limited to, mechanical motion, audio, visual, and tactile
Whether the input is discrete, such as but not limited to, pressing a key, or continuous such as, but not limited to position of a mouse
The number of degrees of freedom involved, such as, but not limited to, two-dimensional mice vs three-dimensional mice used for Computer-Aided Design (CAD) applications

Output devices provide output from the computing device 1100. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 1164:
Input Devices
   Human Interface Devices (HID), such as, but not limited to, pointing device (e.g. mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 1100. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 1100 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data Acquisition (DAQ) devices covert at least one of analog signals and physical parameters to digital values for processing by the computing device 1100. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g. devices disclosed in network 1162 sub-module), data storage device (non-volatile storage 1161), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Aspects

The following disclose various Aspects of the present disclosure. The various Aspects are not to be construed as patent claims unless the language of the Aspect appears as a patent claim. The Aspects describe various non-limiting embodiments of the present disclosure.

Aspect 1. A system for automating loan estimation comprising:
i. one or more processors;
ii. one or more memory resources comprising:
   1. a user loan file database;
   2. a qualifier test database comprising a plurality of qualifier test datapoint sets associated with a plurality of loan types, wherein results associated with each qualifier test determine approval of each loan type;
iii. wherein the one or more memory resources are connectable to a user device through a communications network, wherein the one or more memory resources are executable by the one or more processors to perform the steps of:
   1. receiving a loan estimate request;
   2. receiving input datapoints from a user;
   3. creating a user loan file comprising the input datapoints;
   4. identifying a first loan type from the loan estimate request;
   5. accessing the qualifier test database;
   6. identifying a first set of qualifier tests associated with the first loan type;
   7. populating a plurality of qualifier test datapoint sets with input datapoints, wherein each qualifier test datapoint set comprises datapoints necessary to execute each qualifier test;
   8. monitoring the plurality of qualifier test datapoint sets for completeness;
   9. identifying complete qualifier test datapoint sets, wherein each datapoint in complete qualifier test datapoint sets comprises data associated with the user loan file;
   10. transmitting complete qualifier test datapoint sets to one or more third party system, wherein each third party system processes at least a portion of the complete qualifier test datapoint sets to produce qualifier test results;
   11. receiving qualifier test results;
   12. updating the user loan file with the qualifier test results and populated qualifier test datapoint sets.
      Aspect 2. The system of Aspect 1, wherein the user loan file is stored through blockchain technology.
      Aspect 3. The system of Aspect 1, wherein the one or more memory resources are further executable to perform the steps of:
i. monitoring qualifier test results and user input data for disqualifying values, wherein disqualifying values prevent the user from qualifying for the loan type.
   Aspect 4. The system of Aspect 1, wherein the first qualifier datapoint set is transmitted to the first third party through an external loan origination system.
   Aspect 5. The system of Aspect 4, wherein the one or more memory resources are further executable to perform the steps of:
i. identifying incomplete qualifier test datapoint sets, wherein at least one datapoint is missing data;
ii. assessing whether the missing data requires user input, at least a portion of qualifier test results, or both;
iii. prompting user for missing data requiring user input;
iv. populating incomplete qualifier test datapoint sets with the missing data.
   Aspect 6. The system of Aspect 5, wherein the steps repeat until results are received for the first set of qualifier tests and all of qualifier test datapoint sets are complete.
   Aspect 7. The system of Aspect 1, wherein the one or more memory resources are further executable to perform the steps of:
i. accessing a loan product database comprising a plurality of loan products associated with the first loan type, wherein each of the plurality of loan products comprise minimum qualifying requirements, wherein minimum qualifying requirements comprise predefined threshold values for at least a portion of qualifier test results associated with the first loan type;
ii. comparing qualifier test results to minimum qualifying requirements, wherein comparing determines whether the user qualifies for each of the plurality of loan products.
   Aspect 8. The system of Aspect 7, wherein the one or more memory resources are further executable to perform the steps of:
i. identifying at least one qualified loan product from the plurality of loan products;
ii. applying at least a portion of qualifier test results and populated qualifier test datapoint sets to each qualified loan product, wherein applying determines loan terms for each qualified loan product;
iii. providing loan estimation results comprising loan terms for each qualified loan product.
   Aspect 9. The system of Aspect 8, wherein the one or more memory resources are further executable to perform the steps of:
i. receiving loan product preferences;
ii. filtering the plurality of loan products based on loan product preferences.
   Aspect 10. The system of Aspect 8, wherein the one or more memory resources are further executable to perform the steps of:
i. receiving user acceptance of a first qualified loan product and loan terms, wherein the first qualified loan product is selected from the at least one qualified loan product;
ii. creating a smart contract based on the first qualified loan product and loan terms, wherein the smart contract initiates a lending process.
   Aspect 11. A method for automating loan estimation comprising:
i. receiving a loan estimate request;
ii. receiving input datapoints from a user;
iii. creating a user loan file comprising the input datapoints;
iv. identifying a first loan type from the loan estimate request;
v. accessing a qualifier test database;
vi. identifying a first set of qualifier tests associated with the first loan type;
vii. populating a plurality of qualifier test datapoint sets with input datapoints, wherein each qualifier test datapoint set comprises datapoints necessary to execute each qualifier test;
viii. monitoring the plurality of qualifier test datapoint sets for completeness;
ix. identifying a first complete qualifier test datapoint set, wherein each datapoint in the first complete qualifier test datapoint set comprises data associated with the user loan file;
x. transmitting complete qualifier test datapoint sets to one or more third party system, wherein each third party system processes at least a portion of the complete qualifier test datapoint sets to produce qualifier test results;
xi. receiving qualifier test results;
xii. updating the user loan file with the qualifier test results and populated qualifier test datapoint sets.
   Aspect 12. The method of Aspect 10, wherein the user loan file is stored through blockchain technology.
   Aspect 13. The method of Aspect 10, further comprising:
i. monitoring qualifier test results and user input data for disqualifying values, wherein disqualifying values prevent the user from qualifying for the loan type.
   Aspect 14. The method of Aspect 10, wherein the first qualifier datapoint set is transmitted to the first third party through an external loan origination system.
   Aspect 15. The method of Aspect 14, further comprising:
i. identifying incomplete qualifier test datapoint sets, wherein at least one datapoint is missing data;
ii. assessing whether the missing data requires user input, at least a portion of qualifier test results, or both;
iii. prompting user for missing data requiring user input;
iv. populating incomplete qualifier test datapoint sets.
   Aspect 16. The method of Aspect 15, wherein the process repeats until results are received for the first set of qualifier tests and all of qualifier test datapoint sets are complete.
   Aspect 17. The method of Aspect 10 further comprising:
i. accessing a loan product database comprising a plurality of loan products associated with the first loan type, wherein each of the plurality of loan products comprise minimum qualifying requirements, wherein minimum qualifying requirements comprise predefined threshold values for at least a portion of qualifier test results associated with the first loan type;
ii. comparing qualifier test results to minimum qualifying requirements, wherein comparing determines whether the user qualifies for each of the plurality of loan products.
   Aspect 18. The method of Aspect 17, further comprising:
i. identifying at least one qualified loan product from the plurality of loan products;
ii. applying at least a portion of qualifier test results and populated qualifier test datapoint sets to each qualified loan product, wherein applying determines loan terms for each qualified loan product;
iii. providing loan estimation results comprising loan terms for each qualified loan product.
   Aspect 19. The method of Aspect 18, further comprising:
i. receiving loan product preferences;
ii. filtering the plurality of loan products based on loan product preferences.
   Aspect 20. The method of Aspect 18, further comprising:
i. receiving user acceptance of a first qualified loan product and loan terms, wherein the first qualified loan product is selected from the at least one qualified loan product;
ii. creating a smart contract based on the first qualified loan product and loan terms, wherein the smart contract initiates a lending process.
1. Contract Initiation Data Stage
   1. Retrieving a request for a smart contract to control an asset within a regulated regime
      1. Request for smart contract comprises at least the following initiation parameters:
         1. Personally Identifiable Information (PII) of at least one interested party
         2. Other Data related to Interested Party
   2. Identify Asset for Smart Contract Control
      1. Asset Type
      2. Asset Parameters Based on Asset Type (e.g., Age of Asset, History of Asset, Asset Location)
   3. Identify Asset-based Action to be performed by Smart Contract
      1. Identify Action such as, but not limited to,
         1. Buy
         2. Sell
         3. Trade
         4. Obtain a loan
      2. Desired Performance Parameters:
         1. Minimum and Maximum Tolerances for various parameters
         2. Conditional Accept/Reject Requirements
         3. e.g., term, amount, etc.
   4. Generate Process Datastore (PDS) and store Contract Initiation Parameters in the generated PDS
2. Regulatory Regime Setup Stage
   1. Assess Contract Initiation Data from PDS
      1. Interested party:
         1. Retrieve List of Interested Party
         2. Retrieve Interested Party Metadata associated with each interested party
      2. Asset Data:
         1. Retrieve List of Assets
         2. Retrieve Asset Metadata associated with each Asset
      3. Desired Performance Parameters
   2. Retrieve a list of available Regulatory Regimes
      1. The list is based on at least one of the following:
         1. Jurisdiction over at least one Interested Party
         2. Jurisdiction over at least one Asset
         3. Jurisdiction over at least one Desired Performance Parameter
   3. Filter a plurality of Regulation Regimes from the list of available Regulation Regimes based on, at least in part:
      1. Interested Party Metadata
      2. Asset Metadata
      3. Wherein filtering comprises filtering based on Jurisdiction Data.
   4. Retrieve and Store in the PDS, Smart Contract Requisite Compliance Parameters associated with the at least one applicable Regulatory Regime, comprising:
      Technical Standards based on the at least one applicable Regulatory Regime
      Retrieve and Store Constraints based on selected applicable Regimes
3. Smart Contract Generation/Selection and Deployment Stage:
   1. Generate/Retrieve a smart contract based at least in part on the PDS
   2. Deploy the Smart Contract on the blockchain
4. Asset Oracle and Controller Identification Stage
   1. Identifying of Asset Oracles/Controllers (e.g., Bank)
      1. Retrieve a list of available asset oracles/controllers
      2. Retrieve metadata associated with each asset oracle/controller
         1. Metadata Comprises:
         1. Compliance Requisites (e.g., Verified ID, Credit Score, Etc.)
         1. Retrieve a list Associated Legacy Systems based on Compliance Requisites
         2. Interface Parameters (e.g., communication protocol)
      3. Check Metadata for Adherence to:
         1. PDS, including:
         1. the regulated Regime Standards (compliance parameters)
         2. Contract Initiation Data (e.g., user location & asset type)
      4. Filter only adherent Asset Oracles
   2. Identify Legacy Systems (e.g., FICO/Freddy Mac)
      1. Retrieve a list of available legacy systems associated with each Asset Oracle
         1. This is based on the Compliance Requisites retrieved from each compliant Asset Oracle/controller,
      2. Retrieve metadata associated with legacy systems
         1. Metadata includes:
         1. Interface Parameters (e.g., communication protocol)
      3. Check Metadata for Adherence to:
         1. PDS, including:
         1. the regulated Regime Standards
         2. Contract Initiation Data (e.g., user location & asset type)
      4. Filter out all Asset Oracles that are associated with non-adherent Legacy Systems
      5. Store the list of adherent Oracles in the PDS
   3. Optional Embodiment:
      1. USER INTERFACE ENABLES REVIEW/SELECTION BY:
         1. Borrower, or
         2. Loan Officer
5. Update PDS with Integration Parameters for Interface with each compliant Asset Oracle

In this stage, we take our Contract Initiation Data and send the data to all the compliant oracles and their legacy systems.
1. For each Asset Oracle in the filtered list of asset oracles perform the following:
   1. Retrieve Compliance Requisites required for a compliant integration (e.g., offer)
      1. Retrieve a list of legacy Systems
   2. Interface with each legacy system in the list of the legacy systems to retrieve data required for a compliant integration
   3. Store compliance data comprising retrieved data required for a compliant integration, in the PDS
   4. Generate integration parameters from PDS comprised of, for example, the following (may include other data):
      1. Execute Performance Tests (PTs) on a smart contract Based on:
         1. Contract Initiation Data
         2. Compliance Data, and
         3. Other data provided/modified by any user (Interested party/Loan Officer)
6. Smart contract to Optimize Proposal for Integration

Here we iterate through all Oracles and we tweak performance parameters (e.g., tolerances for loan terms) to get a different integration parameters (proposed loan terms based on qualifications) from each Oracle, we then curate the best parameters to present to the interested party.
1. In some implementations, consumer initiated loan application and origination data commands are mapped to appropriate fields within the LOS automating processes that previously required a manual action.
2. Iterative Feedback process with each Asset Oracle for retrieval of Offer, comprising:
   1. Retrieving PDS
   2. Optimize Performance parameters
      1. Optimized performance parameters based on desired performance parameters
   3. Provide Integration parameters and Optimized Performance parameters
   4. Retrieve Action Proposal(s) from each Asset Oracle
3. Store all Action Proposals in the PDS
7. Contract acceptance

In some embodiments, The final stage of the smart contract will be to generate for the terms of the disposition of the asset in accordance to the asset action based on the legacy system integration parameters, wherein the asset action is designated in the contract initiation data, and wherein the integration parameters are the optimized performance parameters that were originally designated in the contract initiation data.

1. Present Action Proposals to interested party via end-user interface module

2. User accepts an Action Proposal from the list of presented Action Proposals

3. Compliance controller sends signal of acceptance to smart contract

4. Smart contract generates terms for accepted Action Proposal

5. Smart contract provides terms to compliance controller

6. Smart contract terminates

7. Compliance controller provides terms to all parties

Aspect 21. The method of claim 1, wherein the requisite compliance actions comprise:

a performance of an operation as required by the asset controller; and

a sharing of compliance data as required by the asset controller.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method for integrating smart contracts with legacy systems, the method comprising:
defining smart contract initiation data;
generating a smart contract based on the smart contract initiation data;
identifying an asset controller configured to access off-chain data compatible with the smart contract;
accessing metadata associated with the identified asset controller;
verifying the generated smart contract through the metadata associated with the asset controller;
deploying the asset controller to the generated smart contract;
identifying a legacy system through the asset controller,
generating an asset integration parameter for the smart contract in response to the identified compliance related data from the legacy system;
configuring the asset controller to comply with the at least one integration parameter for the legacy system; and
interfacing with the legacy system using the configured asset controller to access a legacy asset.

2. The method of claim 1, wherein defining the smart contract initiation data further comprises defining at least one of:
interested party data,
an asset type, and
asset requirements.

3. The method of claim 1, wherein generating the smart contract further comprises:
a first set of instructions associated with the smart contract initiation data, and
a second set of instructions associated with a qualifier test.

4. The method of claim 1, wherein accessing the metadata associated with the asset controller further comprises accessing the metadata associated with at least one of:
completion characteristics of the contract initiation data,
disqualifying values of the asset controller for the smart contract, and
legacy systems compatible with the asset controller.

5. The method of claim 1, wherein verifying the generated smart contract through the metadata associated with the identified asset controller further comprises comparing smart contract initiation data to the accessed metadata associated with the asset controller.

6. The method of claim 1, wherein identifying the legacy system further comprises:
accessing the metadata associated with the legacy system using the asset controller;
identifying requirements for the legacy system the asset controller;
to identify the legacy system.

7. The method of claim 1, wherein generating the asset integration parameter further comprises generating integration parameters for the generated smart contract and the asset controller.

8. The method of claim 1, wherein configuring the asset controller further comprises generating action proposals from the legacy system, the action proposals corresponding to compliance standards of the asset.

9. The method of claim 1, wherein interfacing with the legacy system further comprises interfacing with a legacy asset associated with the legacy system.

10. A system for integrating smart contracts with legacy systems, the system comprising:
a smart contract interface, the smart contract interface configured to:
receive smart contract initiation data,
identify an asset controller compatible with the smart contract initiation data, and
generate a smart contract based on the smart contract initiation data;
an asset controller configured to:
determine compatibility of the smart contract data with the asset controller,
verify the generated smart contract with the metadata associated with the asset controller,
apply the asset controller to the verified smart contract,
identify a legacy system compatible with the asset controller,
generate an integration parameter for the smart contract based on the identified legacy system,
configure the asset controlled based on the generated integration parameters, and
interface between the smart contract and the legacy system 1; and
the legacy system configured to:
provide operations and transfers of compliance actions,
manage access to legacy assets;

11. The system of claim 10, wherein the smart contract interface is accessed through a web browser, desktop application, mobile application, or other computing device.

12. The system of claim 10, wherein the asset controller enables access to off-chain information inaccessible to the smart contract.

13. The system of claim 10, wherein the asset controller verifies smart contract initiation data through a third-party database.

14. The system of claim 10, wherein the legacy system requires with legacy regulatory requirements.

15. The system of claim 10, wherein the legacy system can be inaccessible from a blockchain.

16. One or more non-transitory computer readable media comprising instructions which, when executed by one or more hardware processors, causes performance of operations comprising:
processing smart contract initiation data;
generating a smart contract based on the smart contract initiation data;
identifying an asset controller based on the smart contract initiation data;
accessing metadata associated with the asset controller based on the generated smart contract;
verifying the generated smart contract with the metadata associated with the asset controller;
incorporating the generated smart contract to the identified asset controller;
identifying a legacy system corresponding to the asset controller;
configuring the asset controller to comply with the identified legacy system;
interfacing between the configured asset controller and the identified legacy system.

17. The one or more non-transitory computer readable media of claim 16, wherein generating a smart contract further comprises publishing the smart contract to a blockchain.

18. The one or more non-transitory computer readable media of claim 16, wherein the verifying the generated smart contract further comprises determining whether the smart contract initiation data can sufficiently identify an asset controller.

19. The one or more non-transitory computer readable media of claim 16, wherein interfacing with the legacy system further comprises accessing an asset associated with the legacy system.

20. The one or more non-transitory computer readable media of claim 16, wherein interfacing with the legacy system further comprises accessing a legacy asset incompatible with a blockchain.
